(19) United States
(12) Patent Application Publication
(10) Pub. No.: US 2022/0127047 A1
(43) Pub. Date: Apr. 28, 2022

(54) CLOSURE SYSTEM FOR CONTAINER

(71) Applicant: 3M INNOVATIVE PROPERTIES COMPANY, St. Paul, MN (US)

(72) Inventor: Matthew P. Thoms, Red Wing, MN (US)

(21) Appl. No.: 17/310,480

(22) PCT Filed: Feb. 4, 2020
(86) PCT No.: PCT/IB2020/050882

§ 371 Date: Aug. 5, 2021

Related U.S. Application Data
(60) Provisional application No. 62/807,848, filed on Feb. 20, 2019.

(51) Int. Cl. B65D 33/28; B65D 33/24; B25H 3/00

(52) U.S. Cl. CPC B65D 33/28; B25H 3/00; B65D 33/24

(57) ABSTRACT

A closure system for a container having a body is provided. The body includes a top edge and defines an internal volume extending from the top edge. The closure system includes a drawstring configured to close the top edge. The closure system also includes an internal flap spaced apart from the top edge. The internal flap includes a first side and a second side. The first side is attached to an inner surface of the body. The second side is detachably connected to the inner surface of the body. The internal flap is configured to cover the internal volume upon connection of the second side to the inner surface of the body.

### TECHNICAL FIELD

The present disclosure relates to a closure system for containers and a container including the closure system.

### BACKGROUND

A container, such as a bucket, bag, and the like, is used to store and/or transport material from one location to another. The container may be used to hold material, such as tools or equipment, related to activities like construction, carpentry, mechanical work, electrical work, and the like. Such material may have considerable bulk and weight. Hence, appropriate safety measures may have to be followed during handling of the container containing such material. Failure to follow the appropriate safety measures may pose a potential safety hazard to personnel present around the containers.

For example, during transportation of the container filled with the tools, the container may be moved from one location to another at a considerable height from a ground surface. In some situations, during movement, the container may accidently open or tip over. In such a situation, the tools may spill out of the container posing a potential safety hazard to personnel present below the container. Hence, a closure assembly may be provided on the container to prevent spilling out of the material contained in the container. However, such a closure assembly may have a complicated usage procedure and/or may not be failsafe.

Additionally, the American National Standards Institute (ANSI) and the International Safety Equipment Association (ISEA) propose a new ANSI/ISEA 121-2018 Dropped Object Prevention Standard. This Standard requires all containers with the closure system to be tested to twice that of their maximum capacity in the inverted state of the container. Such a design may prevent the material contained in the container from exiting the container and causing harm to personnel present below the container if the container were to become inverted in a fall. Hence, there is a need for an improved closure system for such containers.

### SUMMARY

In one aspect, a closure system for a container having a body is provided. The body includes a top edge and defines an internal volume extending from the top edge. The closure system includes a drawstring configured to close the top edge. The closure system also includes an internal flap spaced apart from the top edge. The internal flap includes a first side and a second side. The first side is attached to an inner surface of the body. The second side is detachably connected to the inner surface of the body. The internal flap is configured to cover the internal volume upon connection of the second side to the inner surface of the body.

In another aspect, a container is provided. The container includes a body having a top edge. The body defines an internal volume extending from the top edge. The container also includes a drawstring configured to close the top edge. The container further includes an internal flap spaced apart from the top edge. The internal flap includes a first side and a second side. The first side is attached to an inner surface of the body. The second side is detachably connected to the inner surface of the body. The internal flap is configured to cover the internal volume upon connection of the second side to the inner surface of the body.

In yet another aspect, a container is provided. The container includes a body having a top edge. The body defines an internal volume extending from the top edge. The container also includes a closure system for closing the internal volume. The container is ANSI/ISEA 121-2018 compliant.

### BRIEF DESCRIPTION OF THE DRAWINGS

Exemplary embodiments disclosed herein may be more completely understood in consideration of the following detailed description in connection with the following figures. The figures are not necessarily drawn to scale. Like numbers used in the figures refer to like components. However, it will be understood that the use of a number to refer to a component in a given figure is not intended to limit the component in another figure labeled with the same number.

FIG. 1 is a perspective view of a container in an open position, according to one embodiment of the present disclosure;

FIG. 2 is a schematic side view of the container of FIG. 1;

FIG. 3 is another schematic side view of the container of FIG. 1;

FIG. 4 is another perspective view of the container of FIG. 1 showing an internal flap in an open position;

FIG. 5 is another perspective view of the container of FIG. 4 showing the internal flap in a closed position;

FIG. 6 is another perspective view of the container of FIG. 5 showing a drawstring in a closed position;

FIG. 7 is another perspective view of the container of FIG. 6 showing a buckle in a closed position;

FIG. 8 is another perspective view of the container of FIG. 1 in a closed position; and

FIGS. 9-12 are different perspective views of a test setup of the container of FIG. 1.

### DETAILED DESCRIPTION

In the following description, reference is made to the accompanying figures that form a part thereof and in which various embodiments are shown by way of illustration. It is to be understood that other embodiments are contemplated and may be made without departing from the scope or spirit of the present disclosure. The following detailed description, therefore, is not to be taken in a limiting sense.

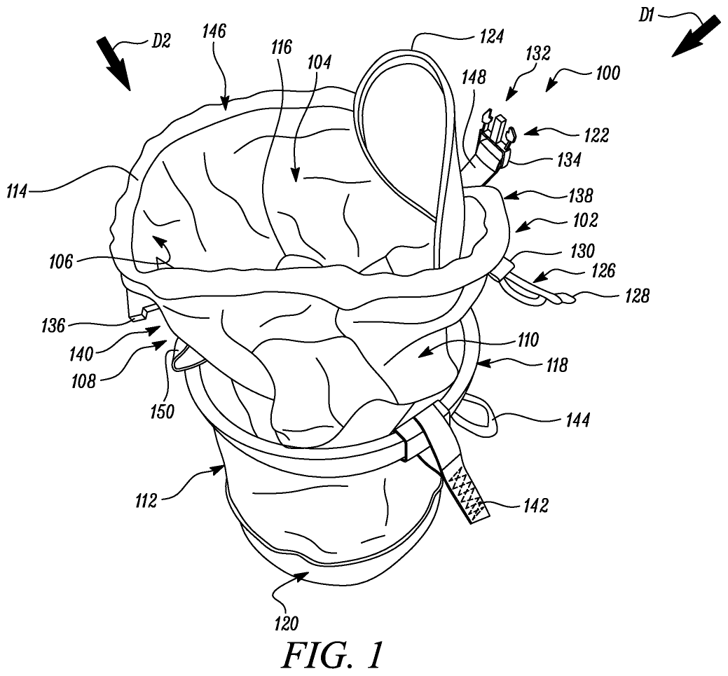

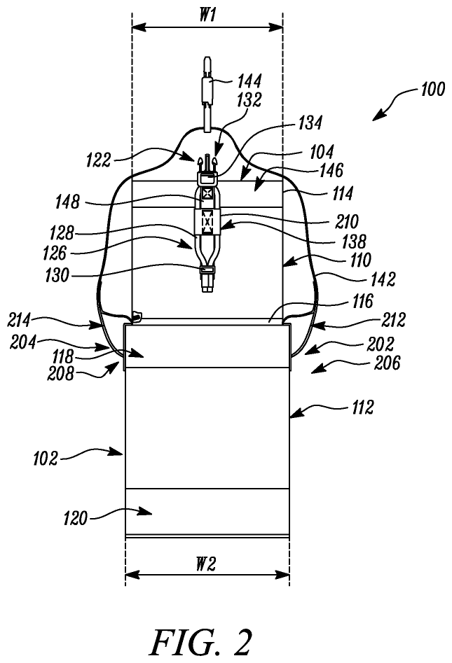

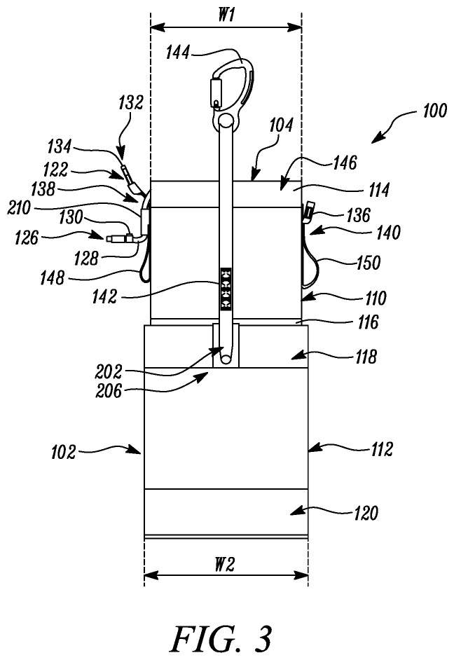

Referring to FIG. 1, a perspective view of a container 100 in an open and extended position is illustrated. Referring to FIG. 2, a side view of the container 100 observed from a viewing direction “D1” (shown in FIG. 1) is illustrated. Referring to FIG. 3, another side view the container 100 observed from a viewing direction “D2” (shown in FIG. 1) is illustrated. The container 100 will now be explained with combined reference to FIGS. 1 to 3. The container 100 may be any type of container, such as a rucksack, a backpack, a knapsack, a handbag, a bucket bag, a pouch bag, a drawstring bag, a basket bag, a flexible or semi-rigid portable container, and the like. The container 100 may be used for storing and/or transporting material, such as industrial tools and equipment used for construction work, carpentry work, mechanical work, electrical work, and the like.

The container 100 includes a body 102. In the illustrated embodiment, the body 102 has a substantially hollow and cylindrical configuration defining an internal volume 104 of the container 100. In other embodiments, the body 102 may have any other configuration, such as rectangular, elliptical, and the like. The body 102 includes an inner surface 106 and an outer surface 108. The body 102 also includes a first portion 110 and a second portion 112. The second portion 112 is attached to the first portion 110. As shown in FIGS. 2 and 3, the first portion 110, in an unfolded and stretched state, forms a substantially cylindrical configuration extending from the second portion 112. Also, the second portion 112 has a substantially cylindrical configuration. Further, a width “W1” defined by the first portion 110 is less than a width “W2” defined by the second portion 112. The first portion 110 has a substantially flexible configuration. In the illustrated embodiment, the first portion 110 is made of a polymer fabric, such as nylon fabric with Polyurethane (PU) backing. In other embodiments, the first portion 110 may be made of any material, such as cotton fabric, other polymer fabric like polyester, natural leather, synthetic leather, tarpaulin, or a combination thereof.

The first portion 110 also includes a top edge 114. The internal volume 104 of the container 100 extends from the top edge 114 into the second portion 112. The first portion 110 also includes a bottom edge 116. The bottom edge 116 is disposed spaced apart with respect to the top edge 114. The bottom edge 116 is attached to the second portion 112. In some embodiments, the bottom edge 116 may be directly attached to the second portion 112, such as by an adhesive, stitching, and the like. In some embodiments, an additional material or fabric (not shown), such as a reinforcing material or fabric, may be attached over an attachment portion (not shown) of the bottom edge 116 and the second portion 112. In the illustrated embodiment, the second portion 112 has a substantially semi-rigid configuration. In other embodiments, the second portion 112 may have a substantially flexible configuration. In the illustrated embodiment, the second portion 112 is made of canvas with hard backing. In other embodiments, the second portion 112 may be made of any material, such as cotton fabric, polymer fabric like polyester or nylon, bonded foam, knit foam, natural leather, synthetic leather, tarpaulin, or a combination thereof. It should be noted that each of the first portion 110 and the second portion 112 may include single or multiple layers of same or different materials.

The second portion 112 includes a top portion 118. In the illustrated embodiment, the top portion 118 includes a rim-like configuration. As such, the top portion 118 has a substantially rigid configuration. In the illustrated embodiment, the top portion 118 is made of a Polyvinyl Chloride (PVC) strip. In other embodiments, the top portion 118 may be made of any material, such as a hardboard strip, a polymer strip, a metal strip, or a combination thereof. The bottom edge 116 of the first portion 110 is attached adjacent to the top portion 118 of the second portion 112. The second portion 112 also includes a base portion 120. The base portion 120 is disposed spaced apart with respect to the top portion 118. In the illustrated embodiment, the base portion 120 has a substantially rigid configuration. In the illustrated embodiment, the base portion 120 is made of a hardboard material, such as Polyethylene (PE). In other embodiments, the base portion 120 may have a substantially flexible configuration. As such, the base portion 120 may be made of any material, such as canvas, cotton fabric, polymer fabric like polyester or nylon, bonded foam, knit foam, natural leather, synthetic leather, tarpaulin, or a combination thereof.

The container 100 also includes a closure system 122. In the illustrated embodiment, the closure system 122 includes an internal flap 124. The internal flap 124 is disposed in the internal volume 104 of the body 102 and attached to the inner surface 106 of the body 102. The internal flap 124 is adapted to selectively open or close the container 100. In the illustrated embodiment, the internal flap 124 has a substantially planar configuration with a circular shape. In other embodiments, the internal flap 124 may have any other configuration, such as rectangular, oval, elliptical, and the like. Also, the internal flap 124 has a substantially semi-rigid configuration. In the illustrated embodiment, the internal flap 124 is made of a hardboard material, such as Polyethylene (PE). In other embodiments, the internal flap 124 may be made of any material, such as canvas, bonded foam, knit foam, natural leather, synthetic leather, tarpaulin, or a combination thereof. The hardboard material may be covered in a fabric, such as canvas, cotton fabric, polymer fabric like polyester or nylon, or a combination thereof.

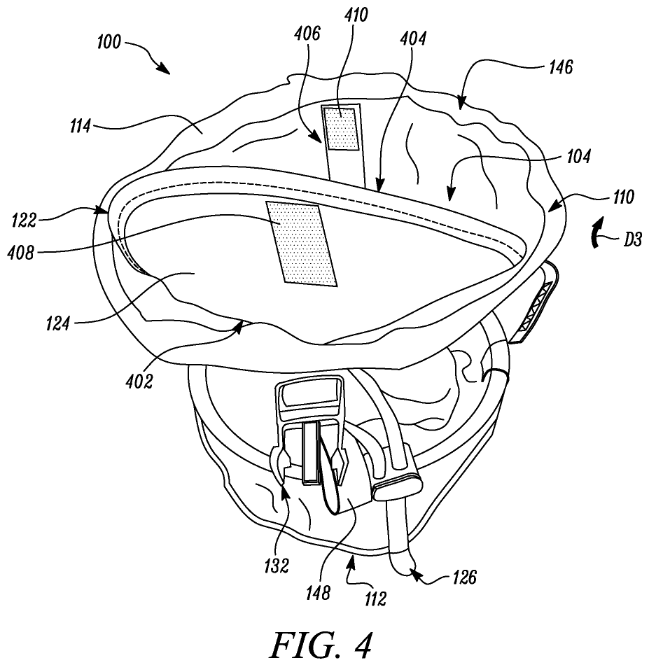

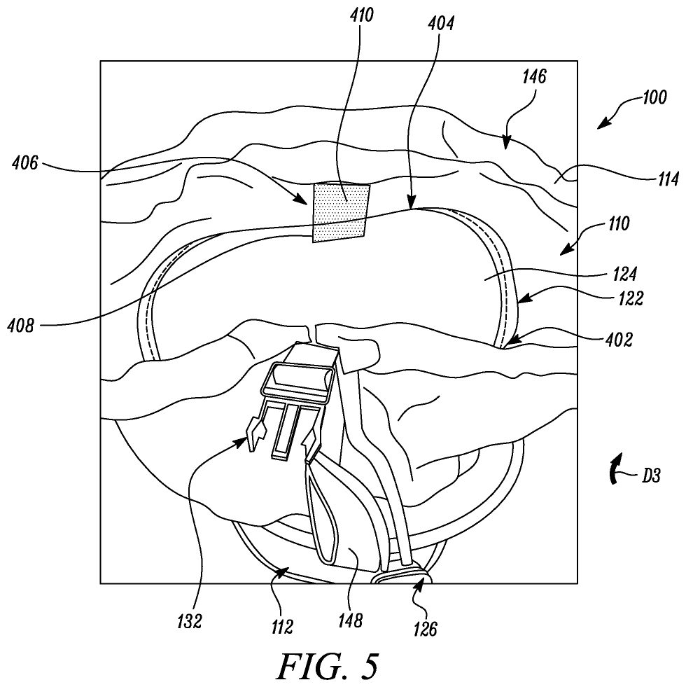

Referring to FIGS. 4 and 5, different perspective views of the container 100 showing the internal flap 124 in an open position and a closed position, respectively, are illustrated. With combined reference to FIGS. 4 and 5, the internal flap 124 incudes a first side 402 and a second side 404. The second side 404 is disposed opposite to the first side 402. The first side 402 is fixedly attached to the inner surface 106 of the body 102. More specifically, the first side 402 is pivotally attached adjacent to the top portion 118 of the second portion 112 of the body 102, such as by an adhesive, stitching, or a combination thereof. As such, the internal flap 124 is disposed in the internal volume 104 of the body 102 and spaced apart with respect to the top edge 114 of the first portion 110 of the body 102. Accordingly, the internal flap 124 may be pivotally moved along a turning direction “D3” about the first side 402 in order to open or close the internal volume 104 of the body 102.

The second side 404 of the internal flap 124 is detachably connected to the inner surface 106 of the body 102. More specifically, the second side 404 of the internal flap 124 is detachably attached to the first portion 110 of the body 102. The internal flap 124 also includes a hook and loop connection 406. The hook and loop connection 406 is adapted to detachably connect the second side 404 to the inner surface 106 of the body 102. In other embodiments, the second side 404 of the internal flap 124 may be detachably attached to the first portion 110 of the body 102 using any other fastening method, such as a button fastener, a snap-fit connection, and the like. More specifically, the hook and loop connection 406 includes a first strip 408 and a second strip 410. In the illustrated embodiment, the first strip 408 forms a hook part of the hook and loop connection 406. The second strip 410 forms a loop part of the hook and loop connection 406.

In other embodiments, the hook part and the loop part of the hook and loop connection 406 may be interchangeably provided on the second strip 410 and the first strip 408, respectively. The hook and loop connection 406 may be any detachable fastener, such as Velcro™. The first strip 408 is disposed on the second side 404 of the internal flap 124. The second strip 410 is disposed on the inner surface 106 of the body 102, and more specifically, on the first portion 110 of the body 102. Upon connection of the first strip 408 and the second strip 410, the second side 404 of the internal flap 124 is attached to the inner surface 106 of the body 102. Accordingly, the internal flap 124 is adapted to cover the internal volume 104 of the body 102 of the container 100 upon attachment to the inner surface 106.

Referring to FIGS. 1 to 5, the closure system 122 also includes a drawstring 126. The drawstring 126 is disposed on the first portion 110 and, more specifically, along the top edge 114 of the first portion 110. The drawstring 126 is adapted to selectively close or open the top edge 114. The drawstring 126 includes a cord 128 and a locking member 130. The cord 128 is disposed in a receptacle 146 provided at the top edge 114 of the first portion 110. The locking member 130 may be slidably attached to the cord 128. In the illustrated embodiment, the cord 128 is made of Polypropylene (PP). In other embodiments, the cord 128 may be made of any material, such as a natural fabric, a polymer like nylon, or a combination thereof.

In the illustrated embodiment, the locking member 130 is a button stopper type locking member made of Polypropylene (PP). In other embodiments, the locking member 130 may be any locking element, such as a clip type locking member, a clamp type locking member, a ratchet type locking member, and the like, and may be made of any material, such as a metal, an alloy, a polymer, and the like. As such, the locking member 130 may be pressed to release the cord 128. Further, the cord 128 may be adjusted through the locking member 130, for example by pulling the cord 128 through the locking member 130 and/or slidably adjusting the locking member 130 on the cord 128. Further, the locking member 130 may be released to lock the locking member 130 on a desired position on the cord 128 in order to selectively close or open the top edge 114.

The closure system 122 also includes a buckle 132. The buckle 132 is attached on the outer surface 108 of the body 102, and more specifically, on the first portion 110 of the body 102. In the illustrated embodiment, the buckle 132 is a clip type buckle. In other embodiments, the buckle 132 may be any buckle, such as a tongue type buckle, a military type buckle, an auto-grip buckle, an auto-lock buckle, a ratchet type buckle, and the like. In the illustrated embodiment, the buckle 132 is made of a polymer, such as nylon, polypropylene, polystyrene, or polythene. In other embodiments, the buckle 132 may be made of any material, such as a metal, an alloy, a polymer, and the like and/or a combination thereof.

The buckle 132 includes a male part 134 and a female part 136. The male part 134 of the buckle 132 is attached to a first side 138 of the first portion 110 using a first strap 148. The male part 134 may be attached to the first strap 148 by various methods, such as adhesives, stitching, and so forth. The male part 134 may be adjusted by adjusting an overall length of the first strap 148. The first strap 148 may be attached to the first side 138 of the first portion 110 by various methods, such as by an adhesive, stitching, and the like. The female part 136 of the buckle 132 is attached to a second side 140 of the first portion 110 of the body 102 using a second strap 150. The female part 136 may be attached to the second strap 150 by various methods, such as adhesives, stitching, and so forth. The female part 136 may be adjusted by adjusting an overall length of the second strap 150. The second strap 150 may be attached to the second side 140 of the first portion 110 of the body 102, such as by an adhesive, stitching, and the like. The second side 140 is disposed opposite to the first side 138. The male part 134 is adapted to detachably connect to the female part 136. As such, upon engagement of the male part 134 with the female part 136, the buckle 132 is adapted to retain the first portion 110 of the body 102 in a closed configuration. Also, upon disengagement of the male part 134 from the female part 136, the buckle 132 is adapted to allow the first portion 110 to be changed to an open configuration.

The container 100 also includes a support strap 142. The support strap 142 is connected to the second portion 112 of the body 102. More specifically, the support strap 142 is connected around the top portion 118 of the second portion 112 of the body 102. Referring to FIGS. 2 and 3, the support strap 142 includes a first end 202 and a second end 204. The first end 202 is connected to a first side 206 of the top portion 118 of the second portion 112 of the body 102 using a first loop 212. The second end 204 is connected to a second side 208 of the top portion 118 of the second portion 112 of the body 102 using a second loop 214. The second side 208 is disposed opposite to the first side 206. The support strap 142 is adapted to lift and support the container 100 during transportation. In the illustrated embodiment, the support strap 142 is made of a polymer, such as nylon. In other embodiments, the support strap 142 may be made of any material, such as a natural fabric, a polymer fabric, or a combination thereof.

The container 100 also includes a loop 210. The loop 210 is provided on the outer surface 108 of the body 102, and more specifically, on the first portion 110 of the body 102. The loop 210 is attached around the cord 128 of the drawstring 126 and the first strap 148 of the male part 134 of the buckle 132. Accordingly, the loop 210 is adapted to receive each of the drawstring 126 and the male part 134 of the buckle 132. As such, the loop 210 places the drawstring 126 and the male part 134 of the buckle 132 adjacent to each other, in turn, improving usability, convenience, and ease of operation. In the illustrated embodiment, the loop 210 is made of an elastomeric polymer, such as polyester. In other embodiments, the loop 210 may be made of any material, such as canvas, cotton fabric, polymer fabric like nylon, bonded foam, knit foam, natural leather, synthetic leather, tarpaulin, or a combination thereof.

Referring to FIGS. 1 to 3, the container 100 further includes a hook 144. The hook 144 is movably connected to the support strap 142. In the illustrated embodiment, the hook 144 is a twist type carabiner hook. In other embodiments, the hook 144 may be any hook element, such as a D-type carabiner hook, a latch-type carabiner hook, a S-type hook, and the like. In the illustrated embodiment, the hook 144 is made of a metal, such as aluminum. In other embodiments, the hook 144 may be made of any material, such as a metal, a polymer, an alloy, or a combination thereof. The hook 144 is adapted to removably suspend the container 100 on a suspender, such as an elevated hook, a crane, and the like.

A method for using the container 100 will now be explained with reference to FIGS. 4 to 8. Referring to FIG. 4, the internal flap 124 is shown in the open position. Also, the closure system 122 including the drawstring 126 and the buckle 132 are also shown in the respective open positions. In such a situation, an open access is provided to the internal volume 104 of the container 100 to be loaded with material (not shown), such as tools. Referring to FIG. 5, the internal flap 124 is closed by turning the internal flap 124 about the first side 402. Also, the first strip 408 and the second strip 410 of the hook and loop connection 406 are attached to one another. Accordingly, the internal flap 124 is attached with respect to the inner surface 106 of the body 102 of the container 100, in turn, closing the access to the internal volume 104.

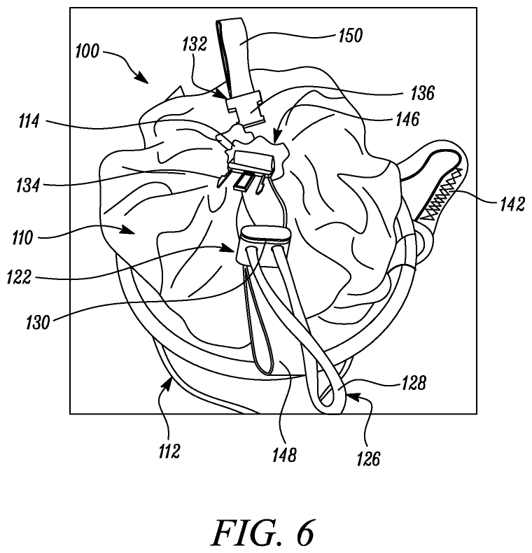

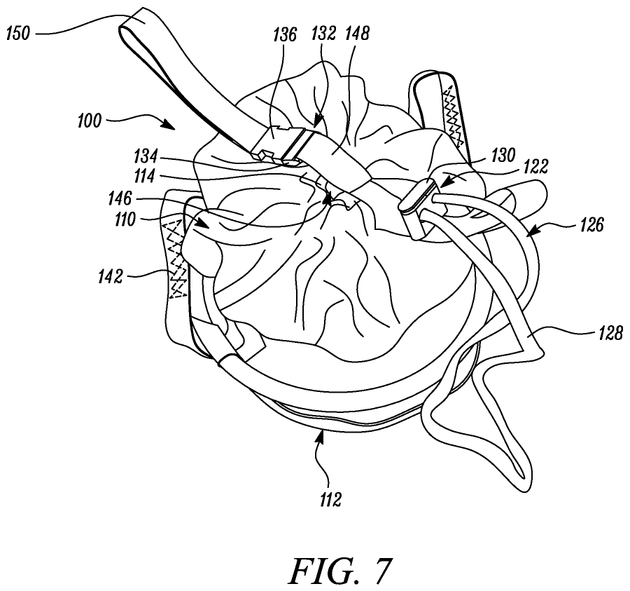

Referring to FIG. 6, the drawstring 126 is tightened in order to close and secure the internal flap 124 in the closed position. More specifically, the cord 128 of the drawstring 126 is pulled and adjusted through the locking member 130. Further, the locking member 130 is locked on the desired position of the cord 128 in order to close the first portion 110 of the body 102. Accordingly, the top edge 114 of the first portion 110 of the body 102 is closed in order to prevent access to the internal flap 124. Referring to FIG. 7, the buckle 132 is connected in order to tightly secure the drawstring 126 and the internal flap 124 in the respective closed positions. More specifically, the male part 134 and the female part 136 of the buckle 132 are engaged with respect to one another in order to secure the drawstring 126 and the internal flap 124 in the respective closed positions. In some embodiments, an overall length of the buckle 132 may be adjusted based on a level of material within the internal volume 104 in order to provide a secure and tight locking of the material underneath the internal flap 124.

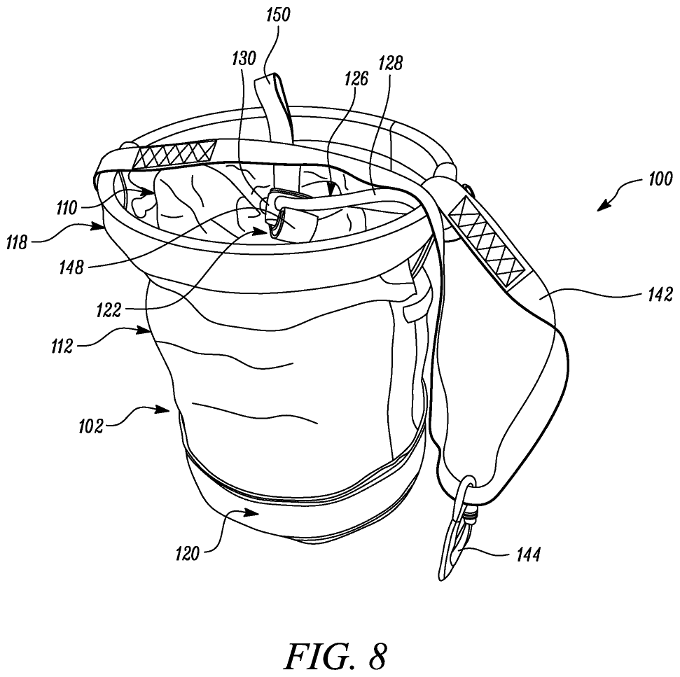

Referring to FIG. 8, another closed position of the container 100 is illustrated. In situations when the level of material in the internal volume 104 may be lower than the top portion 118 of the second portion 112 of the body 102, the first portion 110 may be received into the second portion 112 in a folded state after closing of the top edge 114 of the first portion 110 via the drawstring 126. Further, the buckle 132 may be engaged in order to secure the internal flap 124 and the first portion 110 within the second portion 112 of the body 102 of the container 100.

The American National Standards Institute (ANSI) and the International Safety Equipment Association (ISEA) propose an ANSI/ISEA 121-2018 Dropped Object Prevention Standard. The ANSI/ISEA 121-2018 Dropped Object Prevention Standard will hereinafter interchangeably be referred to as the “Standard”. The Standard requires all containers with a closure system to be tested to twice that of the maximum holding capacity of the container in an inverted state. The Standard is primarily designed to prevent exiting of material contained in the container, when the container may invert or fall, and, thus, prevent harm to personnel around the container due to dropped material.

The container 100 described herein conforms to the Standard. In the illustrated to embodiment, the container 100 has a maximum holding capacity of about 100 Pounds (lbs.). As such, the testing capacity for the container 100 is about 200 lbs. in the inverted state. It should be noted that the maximum holding capacity of the container 100 described herein is merely exemplary and may vary. For example, based on application requirements, different elements of the container 100 including, but not limited to, the first portion 110, the second portion 112, the internal flap 124, the drawstring 126, the buckle 132, the support strap 142, and the hook 144 may be appropriately sized or strengthened or may be constructed with material having appropriate load rating in order to increase or decrease the maximum holding capacity of the container 100. As such, a container (not shown) having a maximum holding capacity of about 250 lbs., and having a configuration similar to the configuration of the container 100, has been tested with about 500 lbs. testing capacity in the inverted state.

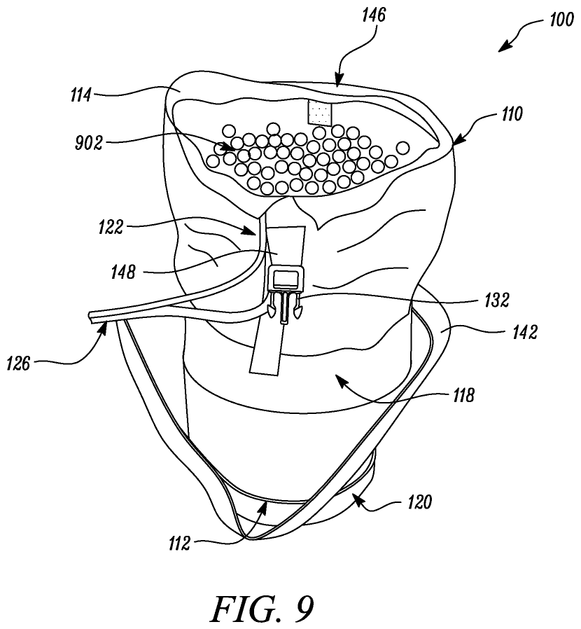

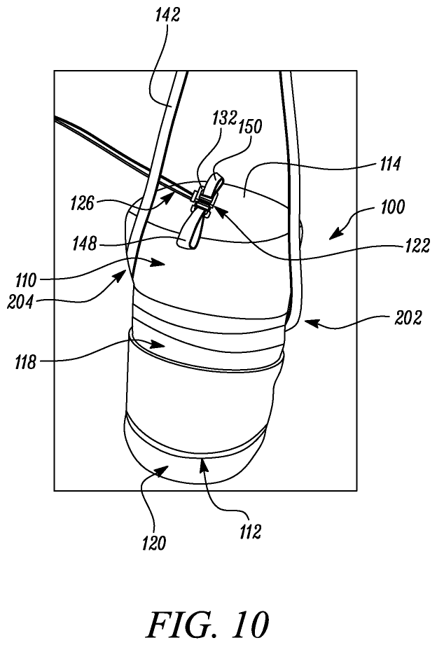

A testing procedure of the container 100 conforming to the ANSI/ISEA 121-2018 Standard will now be explained with reference to FIGS. 9 to 12. Referring to FIG. 9, the internal volume 104 of the container 100 is loaded with exemplary material 902 to be transported. An actual weight of the material 902 loaded in the container 100 is twice that of the maximum holding capacity of the container 100. Referring to FIG. 10, the internal volume 104 of the container 100 is closed as described with reference to FIGS. 4 to 7. More specifically, the internal flap 124 is secured in the closed position via the hook and loop connection 406. The top edge 114 of the first portion 110 is then closed using the drawstring 126. Further, the buckle 132 is engaged in order to tightly secure the internal flap 124 and the top edge 114 of the first portion 110 and, thus, retain the material 902 within the internal volume 104. The container 100 in the closed position is then lifted using the support strap 142 and the hook 144.

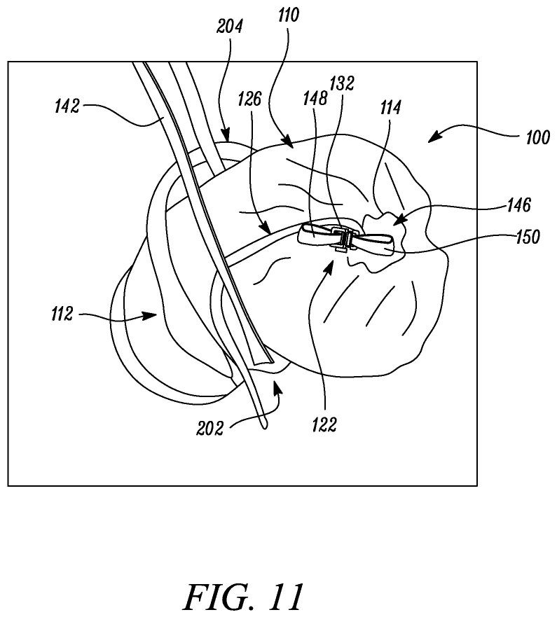

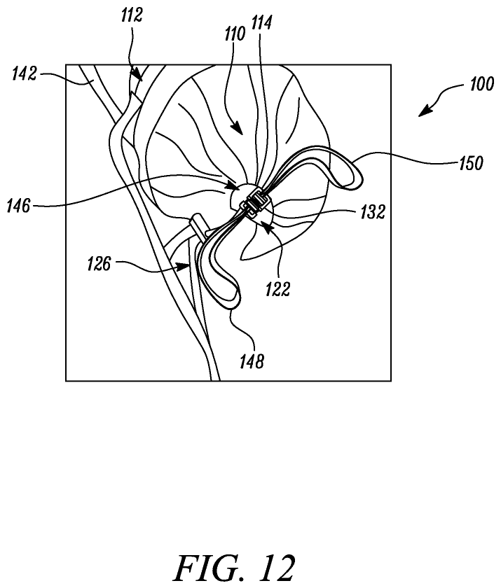

Referring to FIG. 11, the container 100 is inverted about the support strap 142. More specifically, the container 100 is rotated and inverted about each of the first end 202 and the second end 204 of the support strap 142. Referring to FIG. 12, the container 100 is maintained in the inverted position and checked for any signs of failure of the body 102 and/or the closure system 122. As shown, if the closure system 122 successfully holds the material 902 within the internal volume 104 of the container 100 in the inverted position of the container 100, the container 100 may be considered ANSI/ISEA 121-2018 compliant.

The container 100 described herein provides a simple, efficient and cost-effective method to hold and transport material therein with the Standard compliant closure system 122. As such, the closure system 122, including the internal flap 124, the drawstring 126, and the buckle 132, provides a simple, effective, and a failsafe locking of the internal volume 104 of the container 100 while preventing dropping of the material from the container 100 in case of inversion or fall of the container 100. Accordingly, the closure system 122 may provide added protection to personnel present around the container 100 against injury due to dropped material from the container 100. Further, the closure system 122 may be incorporated in any container with little or no modification to the existing system, in turn, improving product compatibility and usability.

Unless otherwise indicated, all numbers expressing feature sizes, amounts, and physical properties used in the specification and claims are to be understood as being modified by the term “about”. Accordingly, unless indicated to the contrary, the numerical parameters set forth in the foregoing specification and attached claims are approximations that can vary depending upon the desired properties sought to be obtained by those skilled in the art utilizing the teachings disclosed herein.

Although specific embodiments have been illustrated and described herein, it will be appreciated by those of ordinary skill in the art that a variety of alternate and/or equivalent implementations can be substituted for the specific embodiments shown and described without departing from the scope of the present disclosure. This application is intended to cover any adaptations or variations of the specific embodiments discussed herein. Therefore, it is intended that this disclosure be limited only by the claims and the equivalents thereof.

1. A closure system for a container having a body, the body having a top edge and defining an internal volume extending from the top edge, the closure system comprising:
a drawstring configured to close the top edge; and
an internal flap spaced apart from the top edge, the internal flap comprising a first side and a second side, wherein the first side is attached to an inner surface of the body and the second side is detachably connected to the inner surface of the body, and wherein the internal flap is configured to cover the internal volume upon connection of the second side to the inner surface of the body.

2. The closure system of claim 1, further comprising hook and loop fasteners configured to detachably connect the second side to the inner surface of the body.

3. The closure system of claim 1, wherein the drawstring further comprises a cord and a locking member coupled to the cord.

4. The closure system of claim 1, further comprising a buckle attached to the body, the buckle comprising a male part and a female part detachably connected to the male part.

5. The closure system of claim 4, further comprising a loop receiving the drawstring and the buckle therethrough.

6. A container comprising:
a body having a top edge, the body defining an internal volume extending from the top edge;
a drawstring configured to close the top edge; and
an internal flap spaced apart from the top edge, the internal flap comprising a first side and a second side, wherein the first side is attached to an inner surface of the body and the second side is detachably connected to the inner surface of the body, and wherein the internal flap is configured to cover the internal volume upon connection of the second side to the inner surface of the body.

7. The container of claim 6, wherein the internal flap further comprises a first strip at the first side, wherein the body further comprises a second strip disposed on the inner surface, the first strip and the second strip forming a hook and loop connection.

8. The container of claim 6, wherein the drawstring further comprises a cord and a locking member coupled to the cord.

9. The container of claim 6, further comprising a buckle attached to the body, the buckle comprising a male part and a female part detachably connected to the male part.

10. The container of claim 9, further comprising a loop receiving the drawstring and the buckle therethrough.

11. The container of claim 6, wherein the body further comprises a first portion having the top edge and a second portion attached to the first portion, wherein the first portion is received within the second portion in a folded state.

12. The container of claim 6, further comprising a support strap connected to the body and a hook coupled to the support strap.

13. A container comprising:
a body having a top edge, the body defining an internal volume extending from the top edge; and
a closure system for closing the internal volume such that the container is ANSI/ISEA 121-2018 compliant.

14. The container of claim 13, wherein the closure system comprises:
a drawstring configured to close the top edge; and
an internal flap spaced apart from the top edge, the internal flap comprising a first side and a second side, wherein the first side is attached to an inner surface of the body and the second side is detachably connected to the inner surface of the body, and wherein the internal flap is configured to cover the internal volume upon connection of the second side to the inner surface of the body.

15. The container of claim 14, wherein the internal flap further comprises a first strip at the first side, wherein the body further comprises a second strip disposed on the inner surface, the first strip and the second strip forming a hook and loop connection.

16. The container of claim 14, wherein the drawstring further comprises a cord and a locking member coupled to the cord.

17. The container of claim 14, further comprising a buckle attached to the body, the buckle comprising a male part and a female part detachably connected to the male part.

18. The container of claim 17, further comprising a loop receiving the drawstring and the buckle therethrough.

19. The container of claim 14, wherein the body further comprises a first portion having the top edge and a second portion attached to the first portion, wherein the first portion is received within the second portion in a folded state.

20. The container of claim 14, further comprising a support strap connected to the body and a hook coupled to the support strap.
